(19) United States
(12) Patent Application Publication
(10) Pub. No.: US 2015/0146598 A1
(43) Pub. Date: May 28, 2015

(54) APPARATUS AND METHOD FOR PERFORMING VIRTUAL HIBERNATION DURING IDLE PERIOD IN WIRELESS LAN SYSTEM, AND TERMINAL DURING IDLE PERIOD OF WIRELESS LAN SYSTEM TERMINAL

(71) Applicant: Electronics and Telecommunications Research Institute, Daejeon (KR)

(72) Inventors: Min Ho Cheong, Daejeon (KR); Hyoung Jin Kwon, Daejeon (KR); Jae Seung Lee, Daejeon (KR); Jae Woo Park, Daejeon (KR); Sok Kyu Lee, Daejeon (KR)

(21) Appl. No.: 14/409,449

(22) PCT Filed: Jun. 19, 2013
(86) PCT No.: PCT/KR2013/005388

§ 371 Date: Dec. 18, 2014

(30) Foreign Application Priority Data
Jun. 19, 2012 (KR) 10-2012-0065407
Jun. 19, 2013 (KR) 10-2013-0070038

(51) Int. Cl. H04W 52/02; H04W 84/12

(52) U.S. Cl. CPC H04W 52/0209; H04W 84/12
USPC 370/311

(57) ABSTRACT

Provided is technology for reducing power consumption of a terminal using hibernation of an access point (AP) managing a network in a wireless local area network (WLAN) environment, and an apparatus for performing hibernation during a rest time during which effective data traffic does not occur in a WLAN system according to an example embodiment, the apparatus may transmit a hibernation message indicating not to respond to a request of terminals during a predetermined period, determine a scheme of performing hibernation and whether to maintain an association between terminals associated before the hibernation is performed, and receive, after the predetermined period of the hibernation, effective data from the terminals.

### TECHNICAL FIELD

The present invention relates to a technology for reducing power consumption of a terminal (STA) using hibernation of an access point (AP) managing a network in a wireless local area network (WLAN) environment.

### BACKGROUND ART

When a wireless local network (WLAN) system is used for a predetermined purpose in a predetermined environment, an application may perform an operation in which operation of a WLAN is time efficient in a predetermined section only. For example, a sensor device may be used in a fitness center, or used as a wideband wireless fidelity (Wi-Fi) covering a range of a department store area.

A fitness center or a department store, which is public facility used for a predetermined purpose, is not opened for 24 hours and is not used for actual work during a predetermined period of time at night. During a period of rest time, an access point (AP) and a station (STA) provided for a purpose of processing sensor traffic of the fitness center may continuously try an access and a channel search which may cause power consumption of the STA during a corresponding period of the rest time although traffic processing is not required during the corresponding period of the rest time.

### DISCLOSURE OF INVENTION

### Technical Goals

An aspect of the present invention provides a method of effectively resting overall functions such as an access trial and a channel search between a station (STA) and an access point (AP) of an application not requiring a transmission of data traffic for a periodical predetermined time section.

Another aspect of the present invention provides a method of preventing loss of overhead time for re-association when hibernation ends, by maintaining an association between an AP and STAs associated before the AP enters into the hibernation.

### Technical solutions

According to embodiments of the present invention, there is provided an apparatus for performing hibernation during a rest time during which effective data traffic does not occur in a wireless local area network (WLAN), the apparatus including a transmitter to transmit a hibernation message indicating not to respond to a request of terminals during a predetermined period, a controller to determine a scheme of performing the hibernation and whether to maintain an association between terminals associated before the hibernation is performed, and a receiver to receive, after the predetermined period of the hibernation ends, effective data from the associated terminals.

The hibernation message may include an indication message of the hibernation or a request message of the hibernation.

The hibernation message may include information associated with at least one of a hibernation start time, a hibernation end time, a hibernation duration, a type indicating a hibernation period or a hibernation occurrence frequency, and whether the association information is maintained, a listen interval is to be frozen, and a maximum idle period (max idle period) is to be frozen.

The scheme of performing the hibernation may include an immediate hibernation scheme, a confirmed hibernation scheme, and a scheduled hibernation scheme.

The controller may determine a hibernation start time and a hibernation time based on a performance scheme determined from among the immediate hibernation scheme, the confirmed hibernation scheme, and the scheduled hibernation scheme.

The immediate hibernation scheme may be a scheme in which the hibernation is performed after the hibernation message is transmitted.

The confirmed hibernation scheme may be a scheme in which the hibernation is performed at a point in time at which a hibernation confirmation message is transmitted based on a response message after the response message is received from terminals.

The scheduled hibernation scheme may be a scheme in which the hibernation is performed based on a schedule including a hibernation start time and a hibernation end time predetermined in the hibernation message.

The receiver may receive, from the terminals, a response message in response to the hibernation message, and the controller may determine whether to perform the hibernation based on feedback from the terminals included in the response message.

The controller may maintain all or a portion of the association between the terminals during the hibernation.

When all or a portion of the association between the terminals is maintained, the controller may freeze a listen interval value of the maintained terminals during the hibernation.

The transmitter may transmit hibernation end message after the hibernation ends.

According to other embodiments of the present invention, there is also provided a terminal for performing hibernation during a rest time during which effective data traffic does not occur in a WLAN, the terminal including a receiver to receive, from an access point, hibernation message indicating not to respond to a request of terminals during a predetermined period, a controller to control an operation of a terminal based on a hibernation scheme included in the hibernation message, and a transmitter to transmit effective data the predetermined period of the hibernation ends.

The controller may generate, in response to the hibernation message, a response message including feedback indicating an agreement or a rejection with respect to the hibernation.

When an association between the controller and the access point is maintained, the controller may perform a channel search and a channel access after the hibernation ends.

According to other embodiments of the present invention, there is also provided a method of performing hibernation during a rest time during which effective data traffic does not occur in a WLAN, the method including transmitting hibernation message indicating not to respond to a request of terminals during a predetermined period, determining a scheme of performing the hibernation and whether to maintain an association between terminals associated before the hibernation is performed, and receiving effective data from the terminals after the predetermined period of the hibernation ends.

The receiving may include receiving, from the terminals, a response message in response to the hibernation message, and the determining may include determining whether to perform the hibernation based on feedback from the terminals included in the response message.

The method of performing hibernation during a rest time during which effective data traffic does not occur in a WLAN may further include maintaining all or a portion of the association between the terminals during the hibernation.

The method of performing hibernation during a rest time during which effective data traffic does not occur in a WLAN may further include freezing, when all or a portion of the association between the terminals is maintained, a listen interval value of the terminals between which the association is maintained, during the hibernation.

### Advantageous Effects

According to embodiments of the present invention, it is possible to prevent stations (STAs) from performing an unnecessary access trial, a channel search trial, and a traffic transmission trial, and to reduce power consumption of the STAs by setting hibernation section which corresponds to a rest time in an access point (AP), in a wireless area network (WLAN) in which periodical or aperiodical data traffic is not demanded.

According to other embodiments of the present invention, it is also possible to prevent loss of overhead time resulting from re-association when hibernation ends, by maintaining an association between an AP and STAs associated before the AP enters into the hibernation.

### BRIEF DESCRIPTION OF DRAWINGS

FIG. 1 illustrates a diagram describing a multi-bandwidth of a wideband wireless local area network (WLAN) system.

FIG. 2 illustrates a WLAN environment including an access point (AP) and a plurality of terminals to which an example embodiment of the present invention may be applied.

FIG. 3 illustrates a block diagram of an apparatus for performing hibernation during a rest time in which effective data traffic does not occur in a WLAN according to an example embodiment of the present invention.

FIG. 4 illustrates a block diagram of a terminal in a WLAN during a rest time in which effective data traffic does not occur according to an example embodiment of the present invention.

FIG. 5 illustrates a method of performing hibernation during a rest time in which effective data traffic does not occur in a WLAN system according to an example embodiment of the present invention.

### BEST MODE FOR CARRYING OUT THE INVENTION

Hereinafter, embodiments will be described in detail with reference to the accompanying drawings.

In terms of a power save of an access point (AP) and a station (STA), a technology for appropriately receiving data traffic without an overlap among wakeup times of the STAs, although the STA wakes up at an allocated time based on a target wake time (TWT) allocated to each STA after the STA enters to a sleep mode, is proposed. The technology enables the AP to recognize that each STA enters the sleep mode for the respective needs and thereby performs coordination. Thus, the STA is provided with an initiative to perform the power save.

However, a corresponding technology may not be efficiently processed with respect to a rest time commonly adapted to all STAs. Since, setting an individual TWT in each STA unit during the rest time is commonly adapted to all STAs, each STA needs to be routinely notified about the rest time through a different pathway, and a separate timing aligning distinguished from the sleep mode of each STA based on a routine TWT setting is required.

At a point in time when the rest time is imminent, communication between the AP and the STA may be inactivated for a long period by extending a listen interval by a corresponding period of the rest time, exceptionally. However, the AP faces a difficulty in controlling an operation time by performing accurate alignment of the STA at a commencement and a termination of the rest time, respectively.

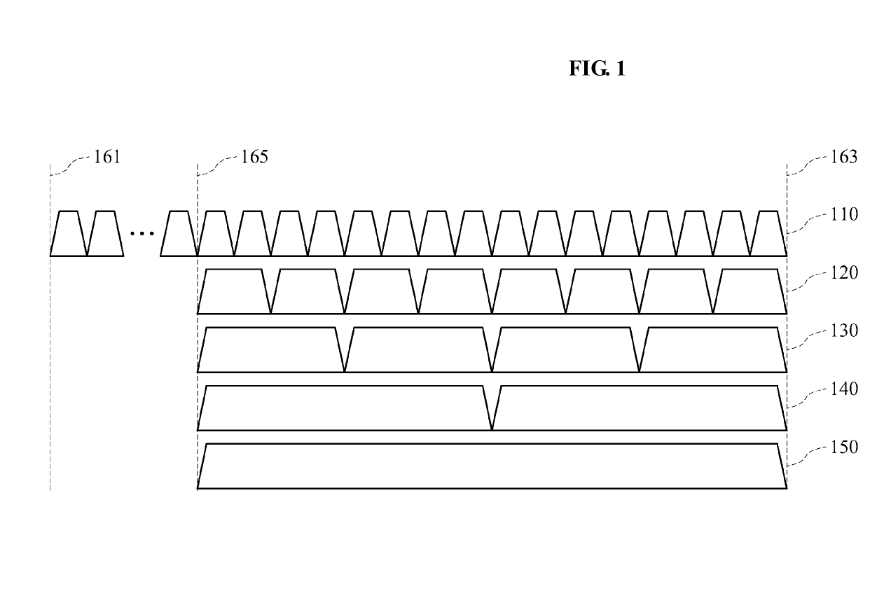

FIG. 1 illustrates a diagram describing a multi-bandwidth of a wideband wireless local area network (WLAN) system.

A wideband WLAN system, for example, a WLAN system defined in the Institute of Electrical and Electronics Engineers (IEEE) 802.11ah standard, may support a multi-bandwidth. The multi-bandwidth may include a first bandwidth having the lowest signal-to-noise ratio (SNR) and a second bandwidth that is two times greater than the first bandwidth. In this instance, a value of the first bandwidth may be 1 megahertz (MHz).

Referring to FIG. 1, the multi-bandwidth may include a 1 MHz bandwidth 110, a 2 MHz bandwidth 120, a 4 MHz bandwidth 130, an 8 MHz bandwidth 140, and a 16 MHz bandwidth 150. A frequency band of the wideband WLAN system may be less than or equal to 1 gigahertz (GHz).

Accordingly, “the multi-bandwidth may be expressed to include 1 MHz, 2 MHz, 4 MHz, 8 MHz, and 16 MHz”.

In FIG. 1, a frequency lower limit value 161 may be a value between 700 MHz and 920 MHz, and a frequency upper limit value 163 may be a value between 750 MHz and 930 MHz.

As illustrated in FIG. 1, the 1 MHz bandwidth 110 may be allocated through an entire channel, and remaining bandwidths, for example, the 2 MHz bandwidth 120, the 4 MHz bandwidth 130, the 8 MHz bandwidth 140, and the 16 MHz bandwidth 150 may be allocated to only a portion of a section of the entire channel.

For example, the 16 MHz bandwidth 150 may be allocated between a predetermined frequency value 165 of FIG. 1 and the frequency upper limit value 163. Referring to FIG. 1, eight channels are allocated to the 2 MHz bandwidth 120, four channels are allocated to the 4 MHz bandwidth 130, and two channels are allocated to the 8 MHz bandwidth 140. However, an allocation of channels illustrated in FIG. 1 is an example and thus, a number of channels and a frequency band may be configured using a variety of methods.

In the present specification, a transmission mode having a value of the 1 MHz bandwidth 110 is referred to as a 1 MHz mode, and a transmission mode having a value of the 2 MHz bandwidth 120 is referred to as a 2 MHz mode.

The 1 MHz mode may refer to a transmission mode that maintains an orthogonal frequency division multiplexing (OFDM) symbol structure and includes 32 subcarriers. In this instance, the 1 MHz mode may use a frequency domain repetition transmission method and thus, may have the lowest transmission rate among bandwidths. However, in the 1 MHz mode, a signal may be transmitted to the farthest distance since the 1 MHz mode has a low SNR.

In a wideband WLAN system using a frequency band less than 1 GHz, terminals may need to fully receive a signal transmitted in the 1 MHz mode and a signal transmitted in the 2 MHz mode.

A WLAN technology using a 5 GHz band discloses a frame structure for dynamic bandwidth allocation. However, direct application of a packet structure of the WLAN technology using the 5 GHz band to the wideband WLAN system using the frequency band less than 1GHz is difficult. Thus, a frame structure suitable for the frequency band less than 1 GHz is required.

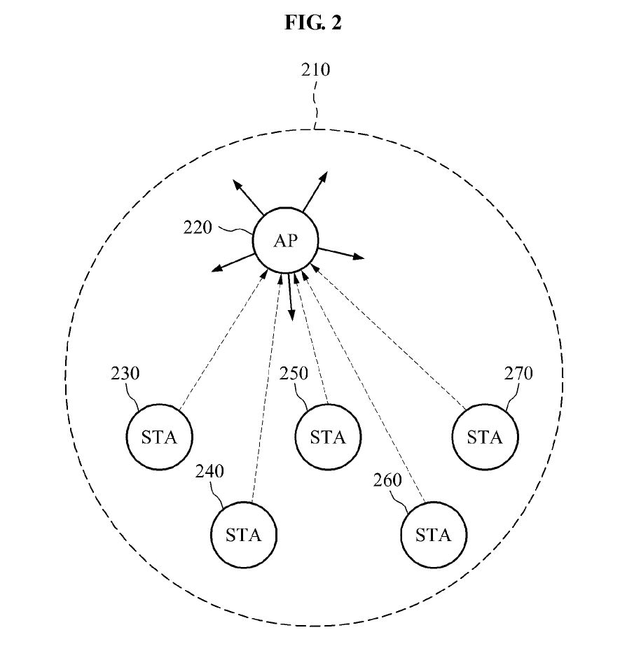

FIG. 2 illustrates a WLAN environment including an access point (AP) and a plurality of terminals to which an example embodiment of the present invention may be applied.

When a WLAN system is used for a predetermined purpose in a predetermined environment, the present invention may be employed when a periodical or aperiodical transfer of data traffic is not required in a predetermined time section. For example, a surveillance network may be provided to a fitness center that is closed at night or around a sensor that operates only when a person is recognized.

To enter overall operations between an AP 220 and each of an STA 230, an STA 240, an STA 250, an STA 260, and an STA 270 into a rest time, a function to transfer information associated with the rest time to an entire network may be provided. An indication of such network dimensions is uniform and thus, relatively efficient when compared to setting a sleep time and a wake time for each STA operation based on each time variable.

Referring to FIG. 2, communication coverage 210 of the AP 220 may include the STA 230, the STA 240, the STA 250, the STA 260, and the STA 270. When a network operation enters a rest time, the AP 220 may broadcast hibernation message indicating not to respond to a request of terminals during a predetermined period to the STA 230, the STA 240, the STA 250, the STA 260, and the STA 270.

During the rest time, the AP 220 may not respond to a data transmission, an access trial, and a channel search requested from the STA 230, the STA 240, the STA 250, the STA 260, and the STA 270.

During the rest time, the STA 230, the STA 240, the STA 250, the STA 260, and the STA 270 receiving a hibernation message may determine whether to perform the data transmission, the access trial, and the channel search based on a determination of each STA.

As another example, when the AP 220 transmits information associated with the rest time using the hibernation message, the STAs may transfer a feedback indicating an agreement or a rejection as a response message. Based on the result, the AP 220 may determine whether to start the hibernation.

Before entering the hibernation, to reduce an amount of overhead time resulting from a reallocation performed after the hibernation ends, the AP 220 may maintain associations with the STA 230, the STA 240, the STA 250, the STA 260, and the STA 270 and enter the hibernation.

To perform simple functions, the AP 220 may sever all associations with the STA 230, the STA 240, the STA 250, the STA 260, and the STA 270, or may selectively sever such associations.

When the AP 220 maintains the associations, a listen interval value of the STA 230, the STA 240, the STA 250, the STA 260, and the STA 270 may be frozen only for a period during which the hibernation is maintained.

When the predetermined period of hibernation ends, the AP 220 may broadcast a hibernation end message to the associated STAs, indicating the end of the hibernation.

When the hibernation end message is transmitted, the STA 230, the STA 240, the STA 250, the STA 260 may newly perform an access trial, the channel search trial, a transmission trial for each set of data traffic, and the like.

The hibernation message or hibernation request and/or instruction message may include a hibernation start time, a hibernation end time, a hibernation duration, a hibernation type, whether the association information is maintained, a listen interval is to be frozen, and a maximum idle period (max idle period) is to be frozen. The hibernation type may indicate a hibernation period, a hibernation occurrence frequency, and the like.

The hibernation start time and the hibernation end time may be set using the following methods.

An immediate hibernation method refers to a method of transmitting the hibernation message and simultaneously entering the AP 220 into the hibernation. For example, the hibernation start time may be set as a transmission time of the hibernation message.

A confirmed hibernation method refers to a method of starting the hibernation at a point in time at which a hibernation confirmation message is transmitted based on a feedback included in a response message of the STA 230, the STA 240, the STA 250, the STA 260 after the AP 220 receives the response message. For example, the AP 220 may transmit the hibernation confirmation message, with an only exception being a case in which all of the STA 230, the STA 240, the STA 250, and the STA 260 are rejected.

A scheduled hibernation method refers to a method of transmitting the hibernation message by including the hibernation start time and the hibernation end time scheduled before hibernation period.

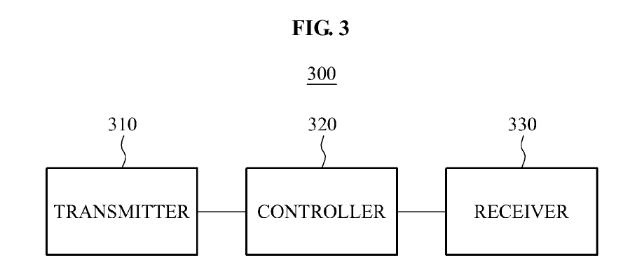

FIG. 3 illustrates a block diagram of an apparatus for performing hibernation during a rest time in which effective data traffic does not occur in a WLAN according to an example embodiment of the present invention.

Referring to FIG. 3, an apparatus 300 for performing hibernation during a rest time in which effective data traffic does not occur may include a transmitter 310, a controller 320, and a receiver 330. The apparatus 300 for performing the hibernation during the rest time in which effective data traffic does not occur corresponds to an AP of a WLAN system. Effective data refers to data including contents exchanged by an AP and an STA in lieu of procedural contents required for a channel access, and the like.

The transmitter 310 may transmit a hibernation message indicating not to respond to a request of terminals during a predetermined period. Here, a hibernation duration is set based on a type of application to which the apparatus 300 is applied, or a user setting.

The hibernation message may include a hibernation indication message or a hibernation request message.

The hibernation message may include information associated with at least one of a hibernation start time, a hibernation end time, a hibernation duration, a type indicating a hibernation period or a hibernation occurrence frequency, and whether the association information is maintained, a listen interval is to be frozen, and a max idle period is to be frozen.

The hibernation message may include information associated with a scheme of performing the hibernation.

The controller 320 may determine the scheme of performing the hibernation and whether to maintain an association between the terminals associated before performing the hibernation.

The scheme of performing the hibernation may include an immediate hibernation method, a confirmed hibernation method, and a scheduled hibernation method.

The controller 320 may determine the hibernation start time and the hibernation end time based on a performance scheme determined from among the immediate hibernation scheme, the confirmed hibernation scheme, and the scheduled hibernation scheme.

The immediate hibernation scheme refers to a scheme in which the hibernation is performed after the hibernation message is transmitted.

The confirmed hibernation scheme refers to a scheme in which the hibernation is performed at a point in time at which a hibernation confirmation message is transmitted based on a response message of terminals after the response message is received from the terminals.

The scheduled hibernation scheme refers to a scheme in which the hibernation is performed based on a schedule including the hibernation start time and the hibernation end time predetermined in the hibernation message.

The receiver 330 may receive effective data from the terminals after the predetermined period of the hibernation ends.

The receiver 330 may receive, from the terminals, a response message in response to the hibernation message, and the controller 320 may determine whether to perform the hibernation based on feedback from the terminals included in the response message.

When all or a portion of the association between the terminals is maintained, the controller 320 may freeze a listen interval value of the maintained terminals during the hibernation.

The transmitter 310 may transmit hibernation end message after the hibernation ends.

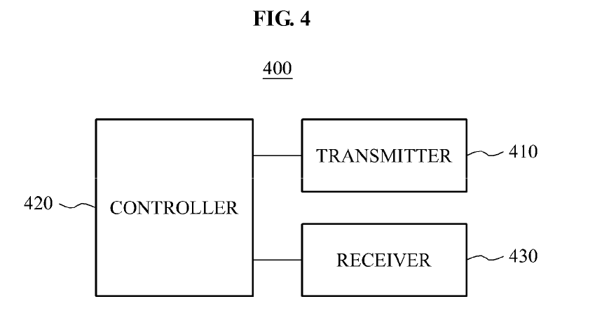

FIG. 4 illustrates a block diagram of a terminal for performing hibernation during a rest time in which effective data traffic does not occur in a WLAN according to an example embodiment of the present invention.

Referring to FIG. 4, a terminal 400 for performing hibernation during a rest time in which effective data traffic does not occur in a WLAN according to an example embodiment may include a transmitter 410, a controller 420, and a receiver 430. The terminal 400 for performing the hibernation during the rest time in which effective data traffic does not occur in a WLAN according to an embodiment corresponds to an STA of a WLAN system.

The transmitter 410 may transmit effective data after a predetermined period of the hibernation ends.

The controller 420 may control an operation of a terminal based on a hibernation scheme included in hibernation message.

The receiver 430 may receive, from an access point, the hibernation message indicating not to respond to a request of terminals during a predetermined period.

The controller 420 may generate a response message including a feedback indicating an agreement or a rejection with respect to the hibernation in response to the hibernation message.

When an association between the controller 420 and the access point is maintained, the controller 420 may perform a channel search and a channel access after the hibernation ends.

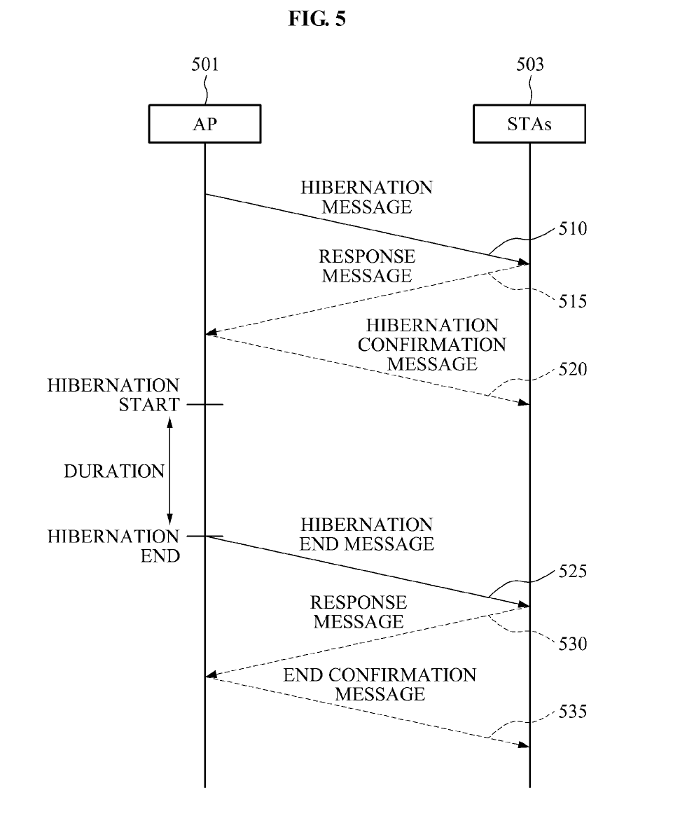

FIG. 5 illustrates a method of performing hibernation during a rest time in which effective data traffic does not occur in a WLAN system according to an example embodiment of the present invention.

In operation 510, an AP 501 according to an example embodiment may transmit hibernation message to STAs 503.

In operation 515, the STAs 503 according to an example embodiment may transmit a response message based on a scheme of performing the hibernation. In terms of an immediate hibernation or a scheduled hibernation, the STAs 503 may not need to transmit the response message. However, in terms of a confirmed hibernation, the STAs 503 may transmit the response message.

In operation 520, the AP 501 may transmit a hibernation confirmation message based on a feedback from the STAs 503 included in the response message. The AP 501 may transmit the hibernation confirmation message when a predetermined number of STAs 503 does not reject the hibernation.

The hibernation may be started at a point in time at which the hibernation confirmation message is transmitted, and the hibernation may ends after a predetermined period ends.

In operation 525, the AP 501 may transmit a hibernation end message when the hibernation ends.

In operation 530, the STAs 503 may transmit a response message in response to the hibernation end message. The response message may include a feedback indicating an agreement or a rejection with respect to the hibernation.

In operation 535, the AP 501 may transmit an end confirmation message based on a response message. The STAs 503 received the end confirmation message may perform a channel search, an access trial, and a transmission of data traffic.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above- described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for performing hibernation during a rest time during which effective data traffic does not occur in a wireless local area network (WLAN), the apparatus comprising:
a transmitter to transmit hibernation message indicating not to respond to a request of terminals during a predetermined period;
a controller to determine a scheme of performing the hibernation and whether to maintain an association between terminals associated before the hibernation is performed; and
a receiver to receive, after the predetermined period of the hibernation ends, effective data from the associated terminals.

2. The apparatus of claim 1, wherein the hibernation message comprises an indication message of the hibernation or a request message of the hibernation.

3. The apparatus of claim 1, wherein the hibernation message comprises information associated with at least one of a hibernation start time, a hibernation end time, a hibernation duration, a type indicating hibernation period or a hibernation occurrence frequency, and whether the association information is maintained, a listen interval is to be frozen, and a maximum idle period (max idle period) is to be frozen.

4. The apparatus of claim 1, wherein the scheme of performing the hibernation comprises an immediate hibernation scheme, a confirmed hibernation scheme, and a scheduled hibernation scheme.

5. The apparatus of claim 4, wherein the controller determines a hibernation start time and a hibernation time based on a performance scheme determined from among the immediate hibernation scheme, the confirmed hibernation scheme, and the scheduled hibernation scheme.

6. The apparatus of claim 4, wherein the immediate hibernation scheme is a scheme in which the hibernation is performed after the hibernation message is transmitted.

7. The apparatus of claim 4, wherein the confirmed hibernation scheme is a scheme in which the hibernation is performed at a point in time at which a hibernation confirmation message is transmitted based on a response message after the response message is received from terminals.

8. The apparatus of claim 4, wherein the scheduled hibernation scheme is a scheme in which the hibernation is performed based on a schedule including a hibernation start time and a hibernation end time predetermined in the hibernation message.

9. The apparatus of claim 1, wherein the receiver receives, from the terminals, a response message in response to the hibernation message, and the controller determines whether to perform the hibernation based on feedback from the terminals included in the response message.

10. The apparatus of claim 1, wherein the controller maintains all or a portion of the association between the terminals during the hibernation.

11. The apparatus of claim 10, wherein when all or a portion of the association between the terminals is maintained, the controller freezes a listen interval value of the maintained terminals during the hibernation.

12. The apparatus of claim 1, wherein the transmitter transmits hibernation end message after the hibernation ends.

13. A terminal for performing hibernation during a rest time during which effective data traffic does not occur in a wireless local area network (WLAN), the terminal comprising:
a receiver to receive, from an access point, a hibernation message indicating not to respond to a request of terminals during a predetermined period;
a controller to control an operation of a terminal based on hibernation scheme included in the hibernation message; and
a transmitter to transmit effective data the predetermined period of the hibernation ends.

14. The terminal of claim 13, wherein the controller generates, in response to the hibernation message, a response message including feedback indicating an agreement or a rejection with respect to the hibernation.

15. The terminal of claim 13, wherein when an association between the controller and the access point is maintained, the controller performs a channel search and a channel access after the hibernation ends.

16. A method of performing hibernation during a rest time during which effective data traffic does not occur in a wireless local area network (WLAN), the method comprising:
transmitting a hibernation message indicating not to respond to a request of terminals to during a predetermined period;
determining a scheme of performing the hibernation and whether to maintain an association between terminals associated before the hibernation is performed; and
receiving effective data from the terminals after the predetermined period of the hibernation ends.

17. The method of claim 16, wherein the receiving comprises receiving, from the terminals, a response message in response to the hibernation message, and the determining comprises determining whether to perform the hibernation based on feedback from the terminals included in the response message.

18. The method of claim 16, further comprising:
maintaining all or a portion of the association between the terminals during the hibernation.

19. The method of claim 18, further comprising:
freezing, when all or a portion of the association between the terminals is maintained, a listen interval value of the terminals between which the association is maintained, during the hibernation.
